(19) United States
(12) Patent Application Publication
(10) Pub. No.: US 2021/0345567 A1
(43) Pub. Date: Nov. 11, 2021

(54) METHOD AND SYSTEM FOR PLANT STRESS DETERMINATION AND IRRIGATION BASED THEREON

(71) Applicants: RUBICON RESEARCH PTY LTD, Hawthorn East, Victoria (AU); THE UNIVERSITY OF MELBOURNE, Victoria (AU)

(72) Inventors: Mark Francis Klemm, Hawthorn East, Victoria (AU); Andrew William Western, Victoria (AU); Dongryeol Ryu, Victoria (AU); David John Aughton, Hawthorn East, Victoria (AU)

(21) Appl. No.: 17/273,931

(22) PCT Filed: Aug. 29, 2019
(86) PCT No.: PCT/AU2019/050919

§ 371 Date: Mar. 5, 2021

(30) Foreign Application Priority Data
Sep. 5, 2018 (AU) 2018903312

(51) Int. Cl. A01G 25/16; G05B 15/02

(52) U.S. Cl. CPC A01G 25/167; G05B 15/02

(57) ABSTRACT

Methods are provided for determining plant stress, including: using a computer-based camera system having thermal imaging and visual imaging to capture foliage at close proximity of at least one plant to provide high resolution images/video thereof; analyzing both thermal and visual images/video therefrom to form a composite image; determining the thermal activity of the composite image/video and photosynthesis state of the at least one plant; and deriving the plant stress from the determination. A handheld computer-based camera system is also provided and includes a smartphone and thermal imaging device.

The present invention claims priority from Australian Provisional Patent Application No. 2018903312 filed on 5 Sep. 2018, the entire contents of which are incorporated herein by reference.

### FIELD

The present invention relates to methods and systems for plant stress determination and automated irrigation management methods and systems based on plant stress determination.

### BACKGROUND

Over agricultural fields, the standard meteorological observations—air temperature, relative humidity, solar radiation, wind speed—are used to estimate the Potential Evapotranspiration (PET), which constitutes the primary use of water in agriculture. PET is calculated conventionally by a Penman-Monteith approach based FAO56 model. PET can be estimated using only the meteorological input and assumes that there is no limitation of water in soil available for the evapotranspiration. Consequently, PET is regarded as the maximum possible water use by crops with given meteorological condition and often overestimates the actual consumption of water by the crops. PET can be converted to the actual evapotranspiration (AET) by adjusting it using crop growth indicator and water stress indicator. AET becomes close to PET as crops are in full growth and in active photosynthetic mode with minimal sign of water stress.

The present invention is an extension of the irrigation management systems and methods disclosed in our International Patent Application No. PCT/AU2018/050858, the full contents including description, claims and drawings of which publication are assumed to have been read and incorporated herein by reference to avoid repetition of description. This patent specification spatially derives soil moisture for any location within an irrigation district and the ability to map the soil moisture at any point in time and spatially across the irrigation district. The derivation is achieved using the monitored inputs of:
1. When the irrigation historical data was applied (including how much was applied and therefore having knowledge of the soil moisture status/level following the irrigation)
2. Computing the continuous evapotranspiration (ET) at the location and therefore the accumulated decline in soil moisture at the location. ET may be derived using the known Penman-Monteith equation together with crop information that computes ET from the following input variables:
   a. Solar radiation
   b. Temperature
   c. Humidity
   d. Wind speed
   e. Crop factor (derived from satellite thermal measurements)
3. Measuring any rainfall events and deducing the precipitation at the location and the subsequent increase in soil moisture at the location
4. Soil type at the location and therefore water holding capacity of the soil. This is used to determine the irrigation point for the soil and therefore the optimal point at which the plant becomes stressed but does not incur any biological damage.

The specification discloses the use of input data from sensors to reflect the highly spatially variable nature of some of these parameters to, in-turn, derive the soil moisture which is also highly spatially variable in nature.

System identification techniques are used to produce an algorithm based on the above inputs and the use of soil moisture sensors at various locations in the field to derive the relationship and provide ongoing calibration.

It is not admitted that any of the information in this patent specification is common general knowledge, or that the person skilled in the art could be reasonably expected to ascertain or understand it, regard it as relevant, or combine it in any way before the priority date.

### SUMMARY OF THE INVENTION

In one aspect of the invention there is provided a method of plant stress determination using a computer-based camera system having thermal imaging and visual imaging to capture foliage at close proximity of at least one plant to provide high resolution images/video thereof; analyzing both thermal and visual images/video therefrom to form a composite image; determining the thermal activity of the composite image/video and photosynthesis state of said at least one plant; and deriving the plant stress from said determination.

In a further aspect there is provided plant stress determination system including a computer-based camera system having thermal imaging and visual imaging to capture foliage at close proximity of at least one plant to provide high resolution images/video thereof; analyzing both thermal and visual images/video therefrom to form a composite image; determining the thermal activity of the composite image/video and photosynthesis state of said at least one plant; and deriving the plant stress from said determination.

Preferably said computer-based camera system is based on a smartphone. In one aspect said thermal imaging is captured by a thermal camera associated with said smartphone and said thermal imaging may be captured by a thermal camera associated with said smartphone.

In a preferred embodiment said thermal and visual images capture at least one or more of information related to time of capture, GPS location, accelerometer data, direction data and inclinometer data.

In a further aspect said composite image uses edge detection of said foliage to align/co-register the visual and thermal images/video and the aligned/co-registered thermal images/video may be processed using augmented reality techniques to provide image measurement.

In a further embodiment the plant stress determination further includes inputs from relevant derived evapotranspiration and soil moisture data from land to be irrigated to provide an irrigation schedule for an operator linked to a networked computer system overseeing said plant stress determination, said relevant derived evapotranspiration and soil moisture data from said land to be irrigated.

Another aspect the plant stress determination is calculated by said computer-based camera system and said thermal imaging and said visual imaging may be synchronized to be taken at the same time.

A further aspect the plant stress determination further includes inputs from a surface representing a non-transpiring leaf whose temperature is measured and a surface representing a transpiring leaf whose temperature is measured.

In yet a further aspect of the invention there is provided an irrigation management system to irrigate predetermined areas of an irrigation district, said irrigation management system including:
(a) a soil moisture determination system to spatially derive the soil moisture at a selected location within an irrigation district to be irrigated, said system including a networked computer system connected to a plurality of weather stations within said irrigation district to measure a selection from: solar radiation spectrum, wind speed, rainfall, temperature, humidity, barometric pressure, and energy measurement from solar panels at each of a plurality of representative locations, said networked computer system having data access to crop factor, soil type, and irrigation historical data at said representative locations, said networked computer system using system identification techniques to produce an algorithm for evapotranspiration based on a predetermined selection from the weather station measurements and the data access to crop factor, soil type, and irrigation historical data at said representative locations; said networked computer system calibrating said algorithm by direct measurement of the moisture in the soil at each of said representative locations by respective soil moisture sensors; and using measured parameters of rainfall, soil type, irrigation historical data and crop factor with said algorithm to derive or interpolate soil moisture at said selected location within said irrigation district;
(b) a plant stress determination system as previously defined associated with said soil moisture determination system to receive said derived soil moisture from said soil moisture system;
   and said irrigation management system monitoring said plant stress from plant stress system; said derived or interpolated soil moisture for said predetermined areas; availability of irrigation water to said predetermined areas; and requests for timed irrigation from end users for said predetermined areas; and allowing requested irrigation to occur for said predetermined areas based on said monitoring.

A still further aspect of the invention provides a method of scheduling irrigation of land including steps of determining plant stress using a computer-based camera system having thermal imaging and visual imaging to capture foliage at close proximity of at least one plant to provide high resolution images/video thereof; analyzing both thermal and visual images/video therefrom to form a composite image; determining the thermal activity of the composite image/video and photosynthesis state of said at least one plant; deriving the plant stress from said determination; wherein the plant stress determination further includes inputs from relevant derived evapotranspiration and soil moisture data from land to be irrigated to provide an irrigation schedule to an operator linked to a networked computer system overseeing said plant stress determination, said relevant derived evapotranspiration and soil moisture data from said land to be irrigated.

In yet a further aspect of the invention there is provided a method of gaining information on atmospheric conditions related to plant stress by using a thermal target that has:
(a) a surface representing a non-transpiring leaf whose temperature is measured and
(b) a surface representing a transpiring leaf whose temperature is measured.

A further aspect of the invention provides method of plant stress determination using a computer-based camera system having visible, near infrared, shortwave infrared, and thermal infrared imaging capability to capture foliage at close proximity of at least one plant to provide high resolution images/video thereof; analyzing selections of composites from said visible and infrared bands in images/video; determining the water stress, leaf water content, leaf pigment condition and photosynthetic activity from the composite image/video of said at least one plant; and deriving the plant stress from said determination.

Preferably said computer-based camera system is based on a smartphone. The near and shortwave infrared imaging can be captured by an infrared camera associated with said smartphone and said thermal imaging is captured by a thermal camera associated with said smartphone.

In a preferred embodiment said thermal, near/shortwave infrared and visual images capture at least one or more of information related to time of capture, GPS location, accelerometer data, direction data and inclinometer data.

The composite image uses edge detection of said foliage to align/co-register the visual and thermal images/video and the aligned/co-registered thermal images/video are processed using augmented reality techniques to provide image measurement.

The plant stress determination further includes inputs from relevant derived evapotranspiration and soil moisture data from land to be irrigated to provide an irrigation schedule for an operator linked to a networked computer system overseeing said plant stress determination, said relevant derived evapotranspiration and soil moisture data from said land to be irrigated.

### BRIEF DESCRIPTION OF DRAWINGS

An embodiment of the method and apparatus will now be described by way of example only with reference to the accompanying drawing in which:

FIG. 1 shows a flow diagram illustrating the components and operation of the plant stress determination system of the present invention;

FIG. 2 is a more enhanced drawing of the flow diagram of FIG. 1 highlighting the components of the plant stress determination system;

FIG. 3 is a front perspective view of a computer-based camera system to provide thermal and visual images that can be used in the plant determination system;

FIG. 4 is a rear perspective view of FIG. 3;

FIG. 5 is a front view of the computer-based camera system of FIG. 3;

FIG. 6 is a cross-sectional view along and in the direction of arrows 6-6 in FIG. 5;

FIG. 7 is an exploded view of FIG. 3 showing the components forming the computer-based camera system;

FIG. 8 is an exploded view of FIG. 4 showing the components forming the computer-based camera system; and

FIG. 9 is a perspective view of the computer-based camera system of FIG. 3 showing the operation of the system in the field.

### DESCRIPTION OF EMBODIMENTS

Embodiments of the present invention seek to provide improvements of our earlier invention disclosed in International Patent Application No. PCT/AU2018/050858 by determining plant stress or water stress at the location. Plant stress (water stress) is a state where the plant is growing in non-ideal growth conditions that increase the demands made upon it. The effects of stress can lead to deficiencies in growth, crop yields, permanent damage or death if the stress exceeds the plant tolerance limits. Accordingly, accurate irrigation for plants will reduce the stress to maximise plant growth and health. In effect the soil moisture is indirectly an indicator of the plant stress. Plant stress is inversely a measure of the plant photosynthesis (i.e. productive growth). As the water stress builds in the plant the photosynthesis begins to decline. There is an optimal point of plant stress when the crop should be irrigated for water use efficiency and plant production. The plant stress may also vary for different stages of the plant growth cycle. For example, higher stress may encourage root penetration of the soil which in turn can improve plant growth.

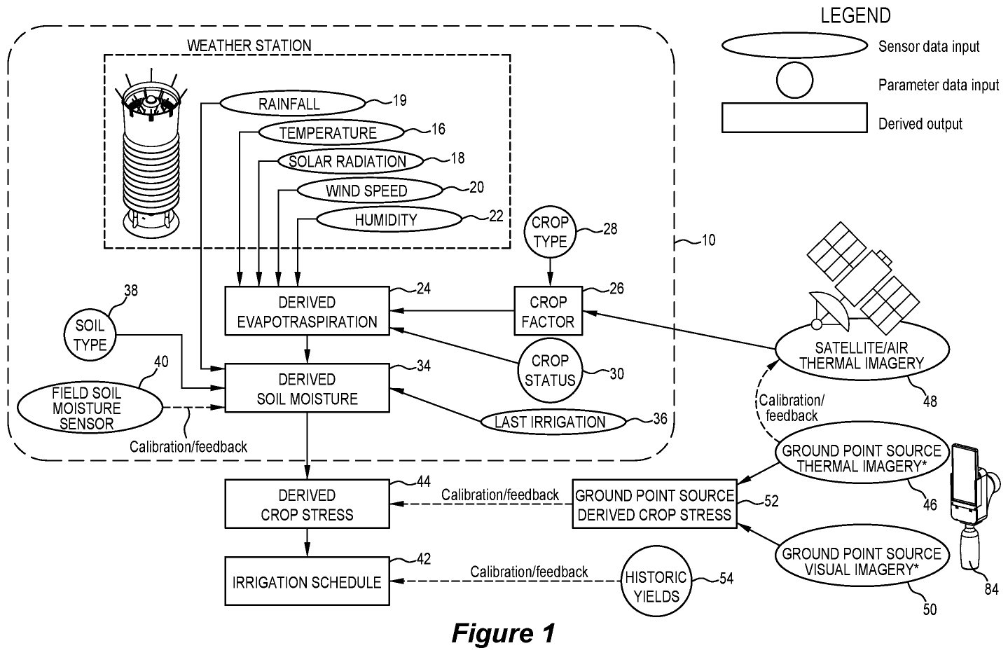

FIG. 1 discloses a flow diagram including the operational aspects of our earlier invention fully described in International Patent Application No. PCT/AU2018/050858, the contents thereof having already been incorporated into this specification and are assumed to have been read. The components and data discussed in our prior application PCT/AU2018/050858 are enclosed within the dashed lines 10. A representative weather station 12 may be associated with a respective flow gate (not shown) incorporated into an irrigation management system (not shown) to provide measured parameters to assist in the derivation of the evapotranspiration as shown in the drawings of our prior application. The weather station 12 inputs are typically temperature 16, solar radiation 18, wind speed 20, atmospheric pressure and humidity 22. Suitable compact weather stations are commercially available. A preferred weather station has been described in International Patent Application No. PCT/AU2018/051205, the full contents including description, claims and drawings of which publication are assumed to have been read and are incorporated herein by reference to avoid repetition of description. An algorithm for evapotranspiration 24 can be derived by a networked computer system (not shown) using the weather station 12 inputs with the addition of crop factor 26 based on readily available satellite/air thermal imagery 32, crop type 28 and crop status 30 through data access by the networked computer system.

The derived evapotranspiration 24 can then allow soil moisture 34 to be determined by the networked computer system. Soil moisture 34 is derived using the inputs of rainfall 14 from weather station 12, irrigation historical data 36 together with soil type 38 stored in the networked computer system. A representative soil moisture sensor 40 is monitored by the networked computer system to provide feedback to calibrate the algorithm used to derive the soil moisture 34. A typical commercially available soil moisture sensor 40 would be 1 metre long and have measurement probes every 10 cm along its length. These measurement probes will provide a better soil moisture analysis as moisture penetration is important as well as surface moisture.

The present invention enhances the operation of the disclosure in International Patent Application No. PCT/AU2018/050858 shown within dashed lines 10. The present invention uses the data from the derived soil moisture 34 as an input into the derivation 44 of plant/crop stress to further finetune irrigation schedules 42 provided by the networked computer system (not shown).

Foliage is the main organ of photosynthesis and transpiration in higher plants. The invention provides field measurement (ground point source) 46 of foliage temperature using a thermal imaging camera (not shown). The measurement is taken at a known GPS location at a point in time. The thermal image is taken by an infra-red camera that is coupled to a smartphone (not shown). The infra-red camera is coupled to the smartphone (directly, or via Bluetooth or other wireless communication). The smartphone is linked to the computer network system. Such a thermal imaging camera is commercially available from FLIR Systems, Inc. for attachment to Apple IOS or Android smartphones. The smartphone can provide the necessary GPS location and the date and time relating to the images taken. The smartphone will run an application for ordering water that has access to the wider data inputs and evapotranspiration 24, soil moisture 34 and plant/crop stress analytics 44. The smartphone will provide a dual image (thermal image 46 from the infra-red camera and visual image 50 from the smartphone camera) of the same view of the crop canopy. The typical use of the smartphone will be to take the images of the crop canopy while the smartphone is handheld with a typical view area size of 1 m×1 m with the smartphone held at a height of approximately 1 m above the ground. The resulting images will have pixel resolution of approximately a millimetre. The infra-red camera will firstly be used to calibrate satellite data 48 having coarse resolution and subject to infrequent satellite passes, typically—one to two weeks. Using known image processing techniques e.g. the open source imaging program ImageJ, the crop canopy image will be processed, and information gained on foliage size/density/colour within the particular view of the image that has been taken. The infra-red image data 46 (e.g. the radiated energy spectra) will also be ‘paired’ with the visual image 50 providing additional data 52 (e.g. thermal analysis) for specific foliage within the view. Of particular focus is the ‘pairing’ of the two images so that the thermal image of the leaf matter is known. The pairing will align or co-register the images. There is a direct correlation between the thermal status (temperature) of the leaf matter and the state of the plant's photosynthesis. The measure of the plant photosynthetic state is inversely proportional to the plant stress. This point source analysis at ground level provides a micro analysis of the crop canopy at close proximity. It allows for an instantaneous indirect measure of the status of the plant's photosynthesis.

The visual image will be analysed to determine the content of the crop canopy in the view using visualisation software. Of particular interest will be the identification of the leaf matter as opposed to other crop content such as stems, including leaf petioles, nodes and internodes, shoots and flowers. The smartphone will also be able to distinguish other non-plant content such as soil. The visual analysis will also be to determine the size of the components identified in the view and establish, for example, if the leaf matter is old growth or new growth.

Plant stress is the object function of soil moisture derivation and estimating the optimal time to irrigate a crop i.e. the irrigation schedule 42. The ground measurement of plant stress will be used within the system identification process to provide ongoing calibration of the irrigation scheduling system. Additional direct inputs to the derivation of plant stress at ground measurement will come from local weather data from weather station 12 such as ambient temperature, humidity, solar radiation, and wind speed. Time of day will also be relevant to the daily plant photosynthesis cycle. Crop type and crop growth stage will also be relevant to the plant stress. These inputs are best accessed via the derived evapotranspiration 24, but not exclusively.

The application for ordering water in the smartphone can also suggest parts of an irrigated area to take ground images to give best representation. For example, it would be beneficial to obtain ground measurements at a range of indicative soil moistures (e.g. low, medium and high). The application for water ordering will not only provide an estimated reading on the plant stress for the crop at that location/time, but will also be used in a broader knowledge base/AI system to refine and calibrate the plant stress prediction system for that location (parameters such as soil type, weather) but also for crop type/variety that in turn can be applied across a wider operation.

Historic data 54 (e.g. yields) will provide feedback and learning on the optimal plant stress levels at which the irrigation schedule 42 can achieve the most efficient water use and at the same time achieve maximum crop production.

The continuous learning and refinement can not only be applied to a specific farm but also used across similar farming enterprises using the same/similar crops and varieties. The platform provides for a wider knowledge base, calibration and learning. This process would employ computer-based data analytics and artificial intelligence algorithms.

The systems Identification techniques will be applied to develop a relationship for plant stress based on data inputs described, and also employing fine tuning and calibration via feedback from field measures such as the smartphone, soil moisture probes 40 and historic yield data 54. The system identification processes described in this invention rely directly on sensor data (e.g. rainfall 14, temperature 16) and input data (e.g. crop type 28, soil type 38) to obtain interim derived outputs (e.g. evapotranspiration 24, soil moisture 34) in the overall process of producing an optimal irrigation schedule 42. The inputs shown in (sensor and input data) to obtain the interim derived outputs are not limited to the shown structure. For example, temperature 16 may be a direct input to deriving plant stress.

An additional embodiment of this patent will be that the smartphone device will provide instant output of the plant stress for the crop captured in the view.

Alternatively, the prior art has described the use of thermal images taken at higher altitudes above the crop canopy using towers or drones/aircraft. These are known as air thermal imaging. Towers provide continuous thermal imaging at a point source. Drones/aircraft provide spatial thermal detail but periodically when the drone/aircraft passes over the crop canopy. Typically, the pixel resolution can be 5 cm for a drone.

Satellite thermal images have also been obtained at a greater altitude again. The higher the altitude of imaging the less resolution there is with detail in the images. Typically, the pixel resolution can be 30 m for a Landsat satellite and 250 m for a MODIS satellite. There is also an averaging associated with both types of thermal imaging. If, for example the crop is planted in rows the thermal image will be an average of the crop canopy and the exposed soil.

Obtaining images at a ground level, in accordance with the invention, overcomes the above resolution problems of both air thermal imaging and satellite thermal images. The analysis that will be undertaken in this process will be able to distinguish between crop canopy and exposed soil. As evapotranspiration occurs in the leaf, and thermal measurement of the leaf is an indication of the rate/level of evapotranspiration and accordingly, crop stress. Thermal measurement of foreign items in the field of view (e.g. stems, weeds or soil) would produce errors in this measurement as they are at a different temperature to that of the leaf. Thus, thermal measurement techniques of a lesser resolution (e.g. satellite/air) cannot distinguish leaf temperature accurately as they are averaging temperatures over a much larger area that includes the foreign items. Typically, the pixel resolution will be 1 mm. This fine resolution can distinguish between leaf matter and stems, including leaf petioles, nodes and internodes, shoots and flowers. The image processing will also be able to distinguish between old growth and new growth through learning techniques. The images will specifically focus on measuring the leaf matter of the crop canopy without interference from extraneous non-leaf based matter in order to measure the photosynthetic status of the plant. These image processing techniques are of a known science and in the public domain.

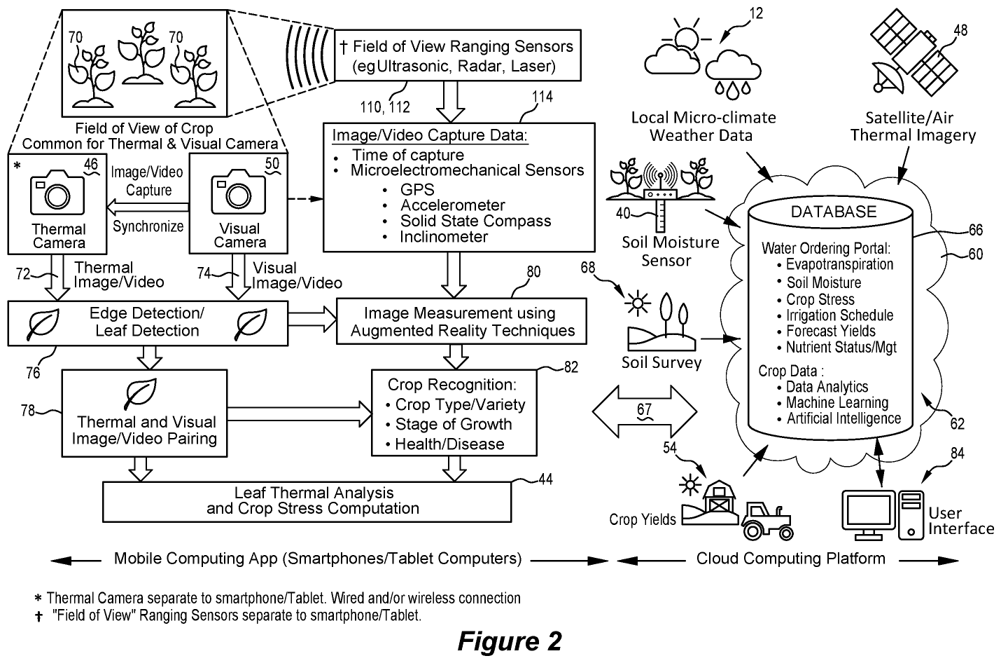

FIG. 2 expands the flow diagram shown in FIG. 1. In order to avoid duplication of description, identical integers in FIG. 1 will have the same reference numerals and function in FIG. 1. The right hand side of FIG. 2 shows a networked computer system 60, typically cloud based, continuously collects data including the derived stress 44 from the irrigation management system 62 and provides operational control based on the irrigation schedules 42 requested from farmers using a remote user interface 64, typically personal computers, personal communication devices (smartphones, tablet computers or similar devices). The networked computer system includes relevant databases 66 and receives data from weather stations 12, satellite imagery 48, nutrient and crop/yield status detection derived from thermal imaging, soil moisture sensors 40, soil surveys 68, and crop yields 54.

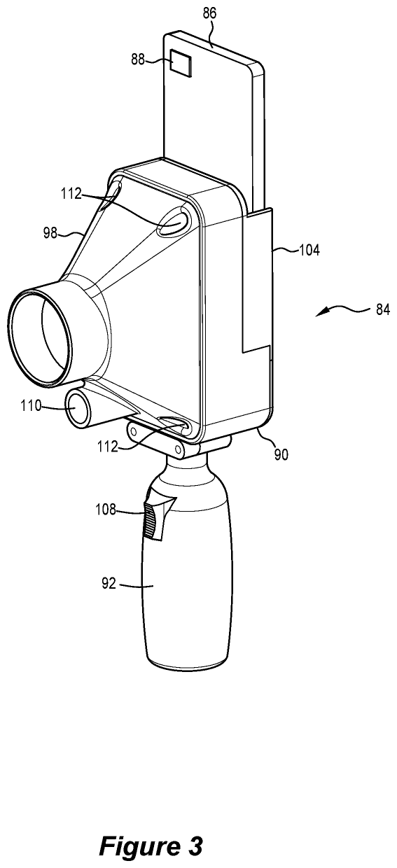

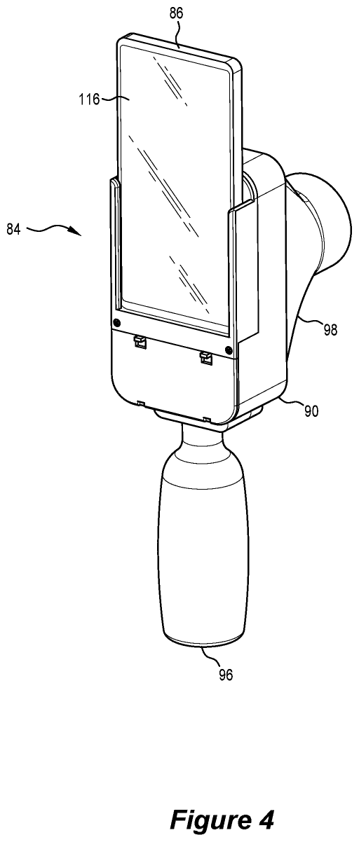

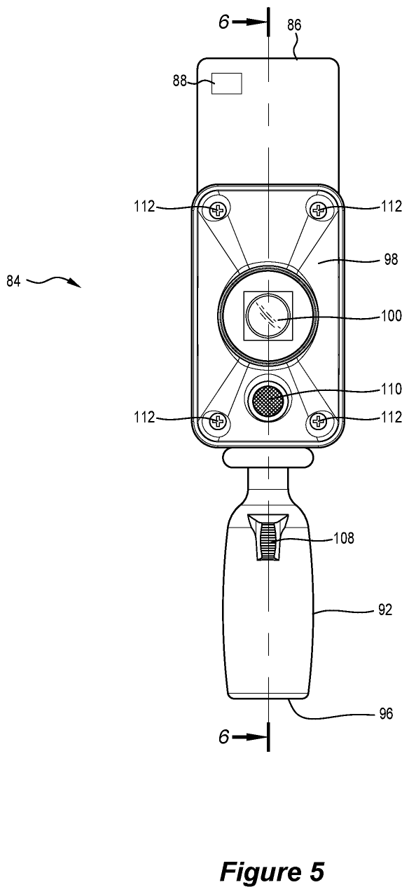

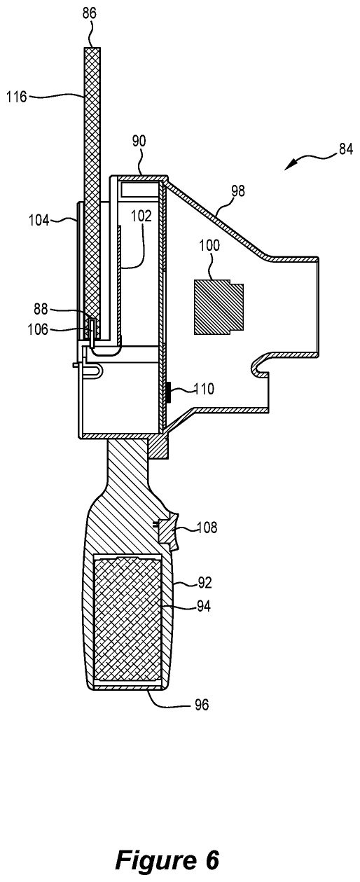

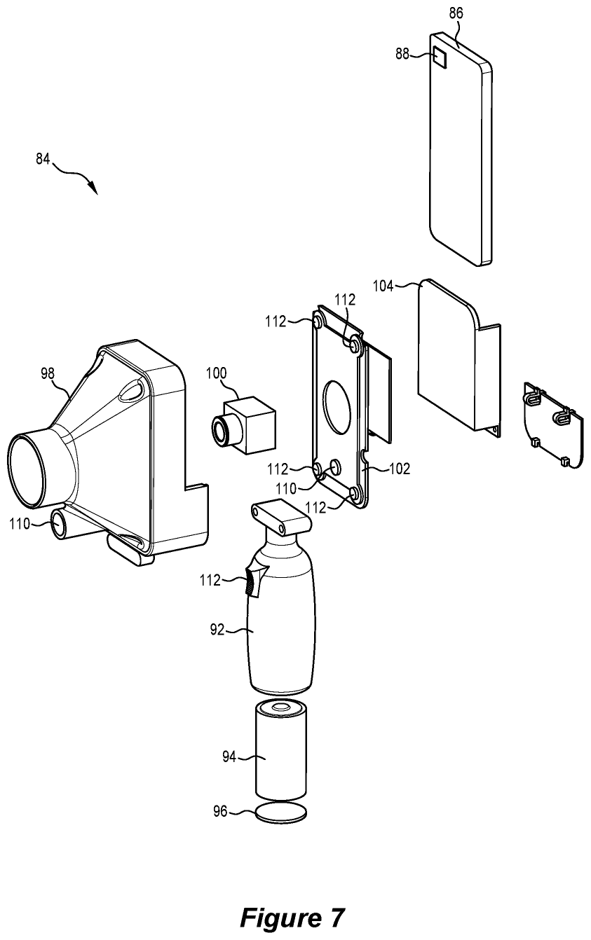

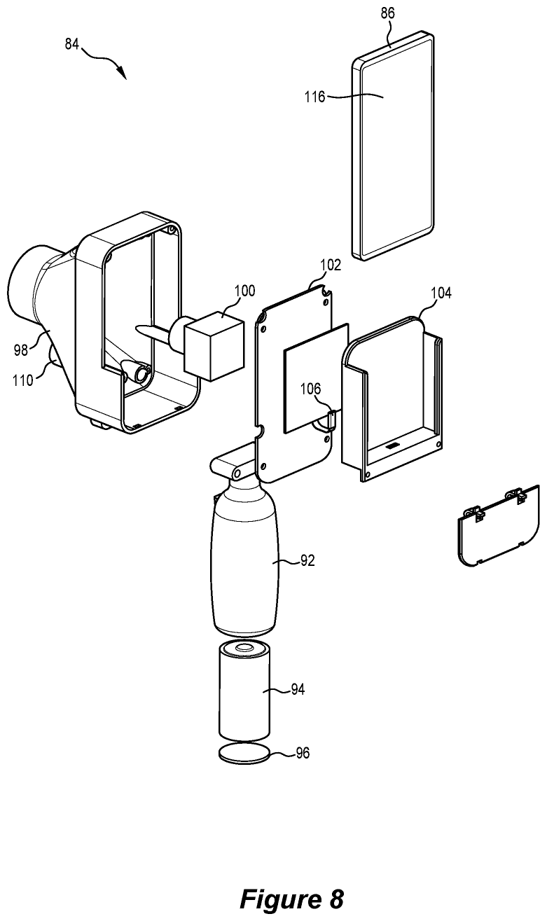

On the left hand side of FIG. 2 the flow chart operation of the thermal imaging camera 46 and visual imaging camera 50 is shown. As previously described, the thermal imaging camera 46 and visual imaging camera may also be substituted by other suitable arrangements and a dedicated system will be later described with reference to FIGS. 3 to 9. The cameras 46,50 will photograph plants 70 in their field of view and can zoom in to isolate foliage, especially leaf matter. Synchronization of images taken will be controlled by visual imaging camera 50 through the software in the smartphone. The thermal image/video 72 and visual image 74 will be processed at 76 in order to detect the leaf and edges from the of the image/video 72 and visual image 74. The processing continues at 78 to pair the images/videos 72,76 so that a thermal analysis can be realized. The results of the processing at 76 is also passed for image/video measurement using augmented reality techniques at 80. The outputs from processes 78 and 80 are analyzed at 82 by algorithms to provide information on crop/plant recognition, crop type and variety, stage of growth, crop/plant health and recognizable diseases. The outputs from 78 and 82 can be analyzed at 44 to derive plant/crop stress which can be passed to database 66. The processing between the smartphone and networked computer system 60 through database 66 is a two way interaction as indicated by double head arrow 67. This interaction provides, for example:
The smartphone (also labelled 86 in FIGS. 3 to 9) having database 66 access to weather station 12 sensors and spatial interpolation specific to the site where the image is being taken.
The potential to upload images and other data obtained from the smartphone when suitable internet access is available.
Uploaded data can provide a growing information base from which machine learning, artificial intelligence and data analysis techniques can be applied in the ongoing improvement and knowledge via feedback mechanisms.

FIGS. 3 to 9 show a handheld computer-based camera system 84 that can replace the previously described smartphone with attached thermal imaging camera. A smartphone 86 with integrated photographic lens(es) 87 will allow visual images and videos to be taken. The smartphone will include a USB connector 88 and Bluetooth wireless communication functionality. The required software to run the handheld system 84 can be installed as an application to control operation thereof and communicate with the networked computer system 60. Smartphone 86 co-operates with a handheld body 90. Body 90 has a handgrip 92 containing a battery 94 and battery cover 96 to power the electronics contained in body 90. A sensor shield 98 will protect the thermal imaging device 100 and related circuitry 102 from ingress of moisture and contaminants. A phone cradle 104 is shaped to snugly fit smartphone 86 and may include a location switch to confirm smartphone 86 is correctly seated in the phone cradle 104. This switch would also trigger automatic Bluetooth ‘pairing’ of smartphone 86. A USB connector 106 can be linked to circuitry 102 to provide coupling with USB connector 88 of smartphone 86.

A switch 108 is coupled to circuitry 102 to provide the simultaneous operation of both the smartphone camera lens(es) 87 and the thermal imaging device 100 for photographing plants 70. A radar or ultrasonic sensor 110 may assist in obtaining measurement data of the plant foliage 70 in conjunction with the MEMS sensors of smartphone 86 and the augmented reality software 80 (FIG. 2). The radar or ultrasonic sensor 110 will provide a distance measurement between plant 70 in the field of view and the computer-based camera system 84. The computer-based camera system 84 may also include one or more laser sensors 112 to further support measurements of plant foliage 70 and assist with image pairing. The laser sensors 112 can be dot or line lasers.

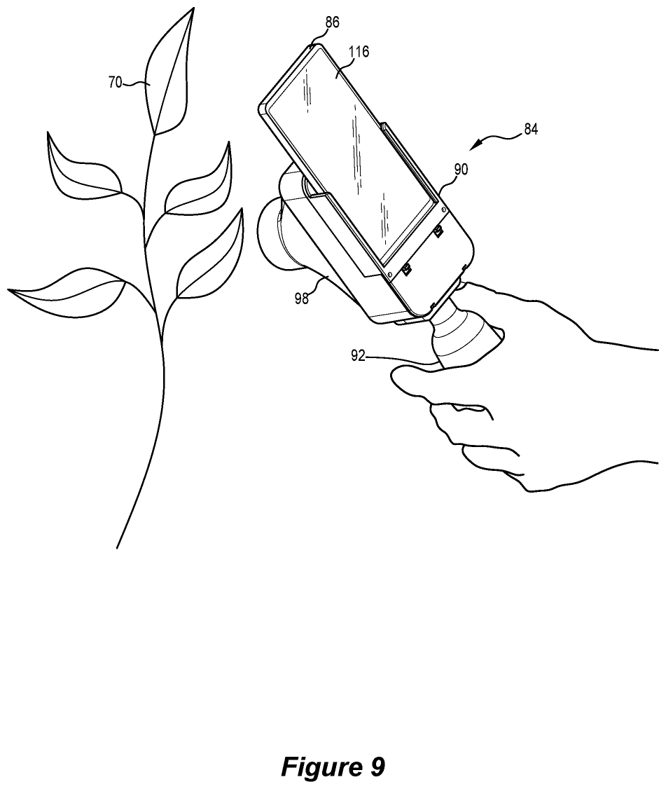

Smartphone 86 will capture data 114 (FIG. 2) related to the processing of image/video. Data 114 may include time of capture and microelectromechanical sensors within smartphone 86 including GPS, accelerometer, solid state compass and inclinometer. FIG. 9 illustrates the use of camera system 84 photographing plant 70. The software may also suggest where to take the image/video and may also require the correct positioning of the handheld computer-based camera system 84 before an image/video can be recorded and crop stress computed/displayed. The software may have control of the angular positioning of the device to ensure a valid ‘Field of View’ is being observed. The computer-based suggestions on positioning can be passed to the user on screen 116.

In an additional embodiment, the camera system 84 may also include a near infrared and/or a shortwave infrared imaging device. Such a device may allow leaf water content information to be determined. The camera system 84 proposed takes advantages of both crop growth/vigour and water stress information measured simultaneously in the close range from the target crop. By combining visible, near infrared, and thermal infrared images along with on-site ancillary information such as local meteorological data, crop type/growth, and portable calibration target, the device can produce plant-by-plant estimates of crop water stress, crop vigour, and water consumption with a minimal reliance on empirical crop parameters.

Embodiments of the invention have been described above by way of non-limiting example only. In practice, a plurality of weather stations 12, flow gates, flow meters and soil moisture sensors 40 are scattered around the irrigation district to provide an extensive irrigation system. Variations and modifications to the embodiments may be made without departing from the scope of the invention.

1. A method of plant stress determination using a computer-based camera system having thermal imaging and visual imaging, the method comprising the following acts performed by the computer-based camera system;
capturing foliage at close proximity of at least one plant to provide high resolution images/video thereof;
analyzing both thermal and visual images/video therefrom to form a composite image;
determining the thermal activity of the composite image/video and photosynthesis state of said at least one plant; and
deriving the plant stress from said determination.

2. The method as claimed in claim 1, wherein said computer-based camera system is based on a smartphone.

3. The method as claimed in claim 2, wherein said thermal imaging is captured by a thermal camera associated with said smartphone.

4. The method as claimed in claim 1, wherein said thermal and visual images capture at least one or more of information related to time of capture, GPS location, accelerometer data, direction data and inclinometer data.

5. The method as claimed in claim 1, wherein said composite image uses edge detection of said foliage to align/co-register the visual and thermal images/video.

6. The method as claimed in claim 5, wherein the aligned/co-registered thermal images/video are processed using augmented reality techniques to provide image measurement.

7. The method as claimed in claim 1, wherein the plant stress determination further includes receiving inputs from relevant derived evapotranspiration and soil moisture data from land to be irrigated and providing an irrigation schedule for an operator linked to a networked computer system overseeing said plant stress determination, based on said relevant derived evapotranspiration and soil moisture data from said land to be irrigated.

8. The method as claimed in claim 1, wherein the plant stress determination is calculated by said computer-based camera system.

9. The method as claimed in claim 1, wherein said thermal imaging and said visual imaging are synchronized to be taken at the same time.

10. A plant stress determination system comprising:
a computer-based camera system having thermal imaging and visual imaging and configured to: capture foliage at close proximity of at least one plant to provide high resolution images/video thereof; analyze both thermal and visual images/video therefrom to form a composite image; determine the thermal activity of the composite image/video and photosynthesis state of said at least one plant; and derive the plant stress from said determination.

11. The plant stress determination system as claimed in claim 10, wherein said computer-based camera system is based on a smartphone.

12. The plant stress determination system as claimed in claim 11, wherein said thermal imaging is captured by a thermal camera associated with said smartphone.

13. The plant stress determination system as claimed in claim 10, wherein said thermal and visual images capture at least one or more of information related to time of capture, GPS location, accelerometer data, direction data and inclinometer data.

14. The plant stress determination system as claimed in claim 10, wherein said composite image uses edge detection of said foliage to align/co-register the visual and thermal images/video.

15. The plant stress determination system as claimed in claim 14, wherein the aligned/co-registered thermal images/video are processed using augmented reality techniques to provide image measurement.

16. The plant stress determination system as claimed in claim 10, wherein a computer-based camera system further includes inputs from relevant derived evapotranspiration and soil moisture data from land to be irrigated and provide an irrigation schedule to an operator linked to a networked computer system overseeing said plant stress determination, based on said relevant derived evapotranspiration and soil moisture data from said land to be irrigated.

17. The plant stress determination system as claimed in claim 10, wherein the plant stress determination is calculated by said computer-based camera system.

18. The plant stress determination system as claimed in claim 10, wherein said thermal imaging and said visual imaging are synchronized to be taken at the same time.

19. An irrigation management system to irrigate predetermined areas of an irrigation district, said irrigation management system including:
(a) a soil moisture determination system configured to spatially derive the soil moisture at a selected location within an irrigation district to be irrigated, said soil moisture determination system including a networked computer system connected to a plurality of weather stations within said irrigation district configured to measure a selection from: solar radiation spectrum, wind speed, rainfall, temperature, humidity, barometric pressure, and energy measurement from solar panels at each of a plurality of representative locations, said networked computer system having data access to crop factor, soil type, and irrigation historical data at said representative locations, said networked computer system using system identification techniques to produce an algorithm for evapotranspiration based on a predetermined selection from the weather station measurements and the data access to crop factor, soil type, and irrigation historical data at said representative locations; said networked computer system calibrating said algorithm by direct measurement of the moisture in the soil at each of said representative locations by respective soil moisture sensors; and using measured parameters of rainfall, soil type, irrigation historical data and crop factor with said algorithm to derive or interpolate soil moisture at said selected location within said irrigation district;
(b) a plant stress determination system associated with said soil moisture determination system to receive said derived soil moisture from said soil moisture determination system, the plant stress determination system comprising:
a computer-based camera system having thermal imaging and visual imaging to capture foliage at close proximity of at least one plant to provide high resolution images/video thereof and being configured to: analyze both thermal and visual images/video therefrom to form a composite image; determine the thermal activity of the composite image/video and photosynthesis state of said at least one plant; and derive the plant stress from said determination;
and said irrigation management system being configured to monitor said plant stress from the plant stress determination system; said derived or interpolated soil moisture for said predetermined areas; availability of irrigation water to said predetermined areas; and requests for timed irrigation from end users for said predetermined areas; and allowing requested irrigation to occur for said predetermined areas based on said monitoring.

20. (canceled)

21. A method of scheduling irrigation of land by determining plant stress using a computer-based camera system having thermal imaging and visual imaging, the method comprising the following acts performed by the computer-based camera system:
capturing foliage at close proximity of at least one plant to provide high resolution images/video thereof;
analyzing both thermal and visual images/video therefrom to form a composite image;
determining the thermal activity of the composite image/video and photosynthesis state of said at least one plant;
deriving the plant stress from said determination;
receiving inputs from relevant derived evapotranspiration and soil moisture data from land to be irrigated and providing an irrigation schedule to an operator linked to a networked computer system overseeing said plant stress determination, based on said relevant derived evapotranspiration and soil moisture data from said land to be irrigated.

22. (canceled)

23. (canceled)

24. A method of gaining information on atmospheric conditions related to plant stress by using a thermal target that has:
(a) a surface representing a non-transpiring leaf whose temperature is measured and
(b) a surface representing a transpiring leaf whose temperature is measured.

25. The method of claim 1, wherein the plant stress determination further includes receiving inputs from a surface representing a non-transpiring leaf whose temperature is measured and a surface representing a transpiring leaf whose temperature is measured.

26. A method of plant stress determination using a computer-based camera system having visible, near infrared, shortwave infrared, and thermal infrared imaging capability, the method comprising the following acts performed by the computer-based camera system;
capturing foliage at close proximity of at least one plant to provide high resolution images/video thereof;
analyzing selections of composites from said visible and infrared bands in images/video;
determining the water stress, leaf water content, leaf pigment condition and photosynthetic activity from the composite image/video of said at least one plant; and
deriving the plant stress from said determination.

27. The method as claimed in claim 26, wherein said computer-based camera system is based on a smartphone.

28. The method as claimed in claim 27, wherein said near and shortwave infrared imaging is captured by an infrared camera associated with said smartphone.

29. The method as claimed in claim 26, wherein said thermal imaging is captured by a thermal camera associated with said smartphone.

30. The method as claimed in claim 26, wherein said thermal, near/shortwave infrared and visual images capture at least one or more of information related to time of capture, GPS location, accelerometer data, direction data and inclinometer data.

31. The method as claimed in claim 26, wherein said composite image uses edge detection of said foliage to align/co-register the visual and thermal images/video.

32. The method as claimed in claim 31, wherein the aligned/co-registered thermal images/video are processed using augmented reality techniques to provide image measurement.

33. The method as claimed in claim 26, wherein the plant stress determination further includes receiving inputs from relevant derived evapotranspiration and soil moisture data from land to be irrigated to provide an irrigation schedule for an operator linked to a networked computer system overseeing said plant stress determination, based on said relevant derived evapotranspiration and soil moisture data from said land to be irrigated.
